(19) United States
(12) Patent Application Publication
(10) Pub. No.: US 2026/0098190 A1
(43) Pub. Date: Apr. 9, 2026

(54) AQUEOUS VINYL ESTER POLYMER EMULSION STABILIZED BY A PROTECTIVE COLLOID AND COMPOSITIONS INCLUDING THE SAME

(71) Applicant: H.B. Fuller Company, St. Paul, MN (US)

(72) Inventors: Chai Chen, St. Paul, MN (US); Joseph Sakher, Stillwater, MN (US); Alex Karczewski, Minneapolis, MN (US); Norma Lawson, Cottage Grove, MN (US)

(21) Appl. No.: 19/347,048

(22) Filed: Oct. 1, 2025

Related U.S. Application Data
(60) Provisional application No. 63/702,944, filed on Oct. 3, 2024.

(51) Int. Cl. C09J 131/04; C09J 11/08

(52) U.S. Cl. CPC C09J 131/04; C09J 11/08

(57) ABSTRACT

Disclosed is an aqueous vinyl ester polymer emulsion that includes a protective colloid that includes polyvinyl alcohol and a component selected from the group consisting of starch, dextrin, and combinations thereof, polyvinyl ester, and water, the polyvinyl ester being stabilized in the emulsion by the protective colloid.

### CROSS REFERENCE TO RELATED APPLICATIONS

This application claims the benefit of U.S. Provisional Application No. 63/702,944, filed Oct. 3, 2024, and incorporated herein.

### BACKGROUND

The invention is directed to stabilizing vinyl ester polymer emulsions using a protective colloid.

Vinyl ester monomers are often polymerized in aqueous compositions in the presence of protective colloids to form stable emulsion polymers. Polyvinyl alcohols, starches and dextrins have been used, independently, as protective colloids for vinyl ester emulsion polymers. Polyvinyl alcohol and aqueous starch solutions are known to be incompatible with one another.

Starch solutions have also been combined with aqueous polyvinyl acetate emulsions to form blended compositions. In such compositions, the starch functions as an additive to alter various properties including, e.g., wet tack and viscosity. However, if the protective colloid in the aqueous polyvinyl acetate emulsion includes polyvinyl alcohol, separation and gelling can occur.

Bio-based materials are materials that are sourced from plants. There is a desire to increase the amount of bio-based material, which is often referred to as “bio-based content,” in adhesive compositions. Many of the components that are used in existing adhesive compositions are derived from petroleum resources. Replacing existing petroleum-derived components in adhesive compositions with bio-based materials is not a straightforward or easy substitution and does not render predictable results.

There is a need for an aqueous polymer emulsion that has an increased bio-based content relative to aqueous polymer emulsions derived from petroleum sources. There is also a need for an aqueous polymer emulsion that can be redispersed after drying.

### SUMMARY

In one aspect, the invention features an aqueous vinyl ester polymer emulsion includes a protective colloid that includes polyvinyl alcohol and a component selected from the group consisting of starch, dextrin, and combinations thereof, polyvinyl ester, and water, the polyvinyl ester being stabilized in the emulsion by the protective colloid.

In another aspect, the invention features an aqueous vinyl ester polymer emulsion prepared by a polymerization process that includes polymerizing monomers in the presence of a protective colloid to produce the aqueous vinyl ester polymer emulsion, the monomers comprising vinyl ester monomers and the protective colloid comprising polyvinyl alcohol and a component selected from the group consisting of starch, dextrin, and combinations thereof.

In one embodiment, the aqueous vinyl ester polymer emulsion includes from 20% by weight to 60% by weight polyvinyl ester, based on dry weight, and the protective colloid includes from 1% by weight to 5% by weight polyvinyl alcohol, based on dry weight, and from 20% by weight to 79% by weight of the component selected from the group consisting of starch, dextrin, and combinations thereof, based on dry weight.

In another embodiment, the protective colloid includes starch and dextrin.

In some embodiments, the protective colloid includes from 10% by weight to 40% by weight starch, based on dry weight, and from 10% by weight to 40% by weight dextrin, based on dry weight.

In other embodiments, the ratio of starch to dextrin is from 90:10 to 10:90.

In one embodiment, the protective colloid includes from 1% by weight to 5% by weight polyvinyl alcohol, based on dry weight.

In another embodiment, the protective colloid includes from 1% by weight to 5% by weight polyvinyl alcohol, based on dry weight, and from 20% by weight to 79% by weight of the component selected from the group consisting of starch, dextrin, and combinations thereof, based on dry weight.

In some embodiments, the aqueous vinyl ester polymer emulsion includes from 20% by weight to 60% by weight polyvinyl ester, based on dry weight, and from 40% by weight to 80% by weight protective colloid, based on dry weight.

In another embodiment, the polyvinyl ester includes polyvinyl acetate, and the aqueous vinyl ester polymer emulsion includes from 20% by weight to 60% by weight polyvinyl acetate, based on dry weight, and from 40% by weight to 80% by weight protective colloid, based on dry weight, and the protective colloid includes from 1% by weight to 5% by weight polyvinyl alcohol, based on dry weight.

In other embodiments, the aqueous vinyl ester polymer emulsion includes from 20% by weight to 60% by weight polyvinyl ester, based on dry weight, the polyvinyl ester being selected from the group consisting of polyvinyl acetate, vinyl acetate/ethylene copolymers, and combinations thereof, and from 40% by weight to 80% by weight protective colloid, based on dry weight, wherein the protective colloid includes from 1% by weight to 5% by weight polyvinyl alcohol, based on dry weight, and from 20% by weight to 79% by weight of the component selected from the group consisting of starch, dextrin, and combinations thereof, based on dry weight.

In one embodiment, the protective colloid includes starch and the starch includes hydroxyethyl starch, hydroxypropyl starch, or a combination thereof.

In another embodiment, the protective colloid includes a bio-based content of at least 30% by weight, based on dry weight.

In other embodiments, the aqueous vinyl ester polymer emulsion includes from 20% by weight to 80% by weight polyvinyl ester, based on dry weight.

In some embodiments, the polyvinyl ester is selected from the group consisting of polyvinyl acetate, vinyl acetate/ethylene copolymers, and combinations thereof.

In other embodiments, the emulsion exhibits an open time of at least 45 seconds.

In another embodiment, the aqueous vinyl ester polymer emulsion exhibits an open time of at least 60 seconds.

In one embodiment, the aqueous vinyl ester polymer emulsion exhibits a viscosity of no greater than 3000 centipoise when measured at 25° C. and a solids content of 56%.

In some embodiments, the dried vinyl ester polymer emulsion is redispersible in water.

In other aspects, the invention features an adhesive composition that includes the aqueous vinyl ester polymer emulsion described above and herein. In one embodiment, the adhesive composition includes the aqueous vinyl ester polymer emulsion described above and herein, and a component selected from the group consisting of plasticizer, humectant, surfactant, defoamer, filler, organic solvent, a second vinyl ester polymer emulsion, rheology modifier, and combinations thereof. In another embodiment, the adhesive composition includes from 5% by weight to 99.95% by weight of the aqueous vinyl ester polymer emulsion described above and herein, and a component selected from the group consisting of from 1% by weight to 30% by weight plasticizer, from 1% by weight to 20% by weight humectant, from 0.05% by weight to 5% by weight rheology modifier, from 0.1% by weight to 1% by weight surfactant, from 0.1% by weight to 1% by weight dispersant, and combinations thereof.

In another aspect, the invention features a binder composition that includes the aqueous vinyl ester polymer emulsion described above and herein, and an organic solvent selected from the group consisting of methanol, ethanol, isopropanol, and combinations thereof.

In other aspects, the invention features a paint composition that includes the aqueous vinyl ester polymer emulsion described above and herein, and pigment.

In other aspects, the invention features a coating composition that includes the aqueous vinyl ester polymer emulsion described above and herein, and optionally a component selected from the group consisting of a coalescent, a surfactant, a dispersant and combinations thereof.

In another aspect, the invention features an article that includes a first fibrous sheet, and a dried vinyl ester polymer emulsion described above and herein disposed on the fibrous sheet.

In another aspect, the invention features a method of making an aqueous vinyl ester polymer emulsion, the method includes combining polyvinyl alcohol, a component selected from the group consisting of starch, dextrin and combinations thereof, and water to form a mixture, heating the mixture to an elevated temperature to form a protective colloid, adding monomers comprising vinyl ester monomers to the protective colloid, and polymerizing the monomers to form the aqueous polyvinyl ester emulsion stabilized by the protective colloid.

The invention features an aqueous vinyl ester polymer emulsion that includes an increased bio-based content relative to polymer emulsions derived from petroleum sources. The dried product of the aqueous polymer emulsion also can be redispersed, which can prove useful in facilitating removal (e.g., cleaning) of the dried aqueous polymer emulsion from equipment that is used to apply the aqueous polymer emulsion.

The invention also features an aqueous vinyl ester polymer emulsion that can be used in articles that are designed to be repulpable or compostable.

Other features and advantages will be apparent from the following description of the preferred embodiments and from the claims.

### Glossary

In reference to the invention, these terms have the meanings set forth below:

The term “bio-based” as used herein means derived directly from a plant.

The term “bio-based content” as used herein means the amount of bio-based components present in a composition.

The term “based on dry weight” refers to the dry weight of all of the ingredients present in the dried emulsion.

### DETAILED DESCRIPTION

The aqueous vinyl ester polymer emulsion includes water and polyvinyl ester stabilized by a protective colloid that includes polyvinyl alcohol and a component selected from the group consisting of starch, dextrin, and combinations thereof.

The aqueous vinyl ester polymer emulsion can be formulated to have any desired solids content. Useful solids contents include, e.g., from 30% by weight to 70% by weight, preferably from 50% by weight to 70% by weight, and more preferably from 55% by weight to 65% by weight. The total solids content of the aqueous vinyl ester polymer emulsion optionally includes trace amounts of initiator (e.g., oxidizing agents, reaction products of oxidizing agents, reducing agents, reaction products of reducing agents, and metal ions).

The aqueous vinyl ester polymer emulsion preferably exhibits a viscosity of less than 5000 centipoise (cP), preferably less than 4000 cP, and more preferably less than 3000 cP when measured at 25° C. and a solids content of 56%, and a change in viscosity of no greater than 2000 cP, no greater than 1000 cP, or even no greater than 500 cP, measured at 25° C., after having been stored in a sealed container at 50° C. for a period of 14 days. The aqueous vinyl ester polymer emulsion is free of visible phase separation and gelling for at least 30 days, and preferably at least 90 days, or even at least 180 days, when stored in a sealed container at 25° C. and observed with the naked eye.

The aqueous vinyl ester polymer emulsion preferably exhibits a number average mean particle size distribution from 0.1 micron (μm) to 1.2 μm, preferably from 0.1 μm to 1.0 μm, more preferably from 0.11 μm to 0.30 μm.

The aqueous vinyl ester polymer emulsion preferably exhibits a volume average mean particle size distribution from 1 μm to 120 μm, preferably from 10 μm to 90 μm, more preferably from 20 μm to 60 μm.

The aqueous vinyl ester polymer emulsion coalesces to form a film upon drying (i.e., is film forming) and preferably forms a film at ambient conditions, at no greater than 25° C., or even at no greater than 23° C., as determined according to the Minimum Film Forming Temperature (MFFT) Test Method. The dried vinyl ester polymer emulsion preferably can be redispersed with water after drying.

The aqueous vinyl ester polymer emulsion preferably exhibits an open time of at least 20 seconds, at least 40 seconds, at least 45 seconds, or even at least 60 seconds.

The aqueous vinyl ester polymer emulsion preferably exhibits no microbial growth (also referred to herein as “microbial resistance”) after having been stored in a sealed container for at least 30 days, at least 60 days, or even at least 90 days and then tested according to the Microbial Resistance Test Method.

### Polyvinyl Ester

The polyvinyl ester is derived from vinyl ester monomers of alkanoic acids having from one to 18 carbon atoms and, optionally, ethylenically unsaturated comonomer. Suitable vinyl ester monomers include, e.g., vinyl acetate, vinyl propionate, vinyl butyrate, vinyl iso-butyrate, vinyl pivalate, vinyl neodecanoate, vinyl neononanoate, vinyl laurate, vinyl stearate, isopropenyl acetate, vinyl 2-ethylhexanoate, and combinations thereof.

Useful ethylenically unsaturated comonomers that can be polymerized with the vinyl ester monomer include, e.g., alkylenes having from two to four carbon atoms (e.g., ethylene and propylene), maleates (e.g., diethyl maleate, dibutyl maleate, di(2-ethylhexyl) maleate, dioctyl maleate, and combinations thereof), fumarates (e.g., dibutyl fumarate, di(2-ethylhexyl) fumarate, and combinations thereof), and combinations thereof.

Useful examples of polyvinyl esters include polyvinyl acetate, vinyl acetate copolymers (e.g., vinyl acetate/ethylene copolymers), and combinations thereof.

The polyvinyl ester preferably is present in the aqueous vinyl ester polymer emulsion in an amount of at least 20% by weight, at least 30% by weight, no greater than 60% by weight, from 40% by weight to 60% by weight, or even from 20% by weight to 60% by weight, based on dry weight.

### Protective Colloid

The protective colloid includes polyvinyl alcohol and starch, dextrin, or both starch and dextrin. The protective colloid is present in the aqueous vinyl ester polymer emulsion in an amount of at least 21% by weight, at least 25% by weight, at least 40% by weight, no greater than 80% by weight, from 40% by weight to 80% by weight, or even from 40% by weight to 55% by weight, based on dry weight. The protective colloid preferably includes a bio-based content of at least 90% by weight, or even at least 95% by weight, based on dry weight.

The protective colloid preferably includes at least 20% by weight, at least 30% by weight, no greater than 80% by weight, no greater than 79% by weight, from 20% by weight to 80% by weight, from 20% by weight to 79% by weight, from 40% by weight to 80% by weight, from 40% by weight to 79% by weight, or even from 35% by weight to 50% by weight starch, dextrin, or a combination of starch and dextrin, based on dry weight.

When both starch and dextrin are part of the colloid, the ratio of starch to dextrin, based on dry weight, preferably is from 10:90 to 90:10. When both starch and dextrin are part of the colloid, the total amount of starch and dextrin in the colloid is at least 20% by weight, at least 30% by weight, no greater than 80% by weight, no greater than 79% by weight, from 40% by weight to 80% by weight, from 40% by weight to 79% by weight, or even from 35% by weight to 50% by weight, based on dry weight.

### Polyvinyl Alcohol

Useful polyvinyl alcohols include partially hydrolyzed polyvinyl alcohols and fully hydrolyzed polyvinyl alcohols. Useful partially hydrolyzed polyvinyl alcohols have a degree of hydrolysis of from 80 mol % to 99 mol %, or even from 85 mol % to 95 mol %. The polyvinyl alcohol component can include a single polyvinyl alcohol, or a combination of two or more different polyvinyl alcohols having differing degrees of hydrolysis.

Useful polyvinyl alcohols have a molecular weight, as measured by viscosity, of at least 3 cP, from 5 cP to 60 cP, or even from 40 cP to 60 cP, when measured on a 4% polyvinyl alcohol aqueous solution at 20° C., as reported by the manufacturer.

Useful polyvinyl alcohols are commercially available under a variety of trade designations including, e.g., under the SELVOL series of trade designations from Sekisui Specialty Chemicals America, LLC (Dallas, Texas) including SELVOL 540 polyvinyl alcohol having 88 mole % hydrolysis, SELVOL 205 polyvinyl alcohol having from 87 mole % to 89 mole % hydrolysis, SELVOL 523 polyvinyl alcohol having 87 mole % to 90 mole % hydrolysis, all hydrolysis values as reported by the manufacturer, and under the CHANG-CHUNG BP series of trade designations from Chang Chun Group (Zhongshan District 104070, Taipei, Taiwan) including CHANG-CHUNG BP-05, CHANG-CHUNG BP-17, and CHANG-CHUNG BP-24 partially hydrolyzed polyvinyl alcohols.

The aqueous polyvinyl ester emulsion preferably includes at least 1% by weight, at least 2.5% by weight, no greater than 5% by weight, or even from 1% by weight to 5% by weight polyvinyl alcohol, based on dry weight.

### Starch

Useful starches include, e.g., natural starches, starches modified to include at least one additional functional group, and combinations thereof.

Useful natural starches and sources of starch include, e.g., corn starch, wheat starch, potato starch, arrowroot starch, rice starch, sago starch, barley starch, sorghum starch, rye starch, triticale, tapioca starch, waxy maize starch, waxy sorghum starch, sweet potato starch, waxy rice starch, mung bean starch, pea starch, and combinations thereof.

Useful modified starches include e.g., chemically modified starches, enzymatically modified starches, physically modified starches (e.g., with heat), and combinations thereof. Suitable classes of modified starches include, e.g., starch esters, starch ethers (e.g., cationic starches, hydroxyethyl starches, and hydroxypropyl starches), starch acetates (i.e., acetylated starch), starch phosphates, oxidized starches (e.g., starches oxidized using a variety of reagents including, e.g., hypochlorites, persulfates, peroxides, permanganates, perborates, and combinations thereof), bleached starches, and combinations thereof. Particularly useful starches include natural starches modified to include additional hydroxyl groups, alkyoxy groups, carboxyl groups (e.g., carboxymethylated starch), and combinations thereof. Examples of useful modified starches include oxyalkylated starches (i.e., hydroxy alkyl ethers of starch) in which the alkyl unit has from one to six carbon atoms (e.g., hydroxyethylated starch, hydroxypropylated starch, and combinations thereof), hydroxypropyl distarch phosphate, glycerol carboxymethyl starch, methyl-alpha-D-glucoside (also known as methyl-alpha-D-glucopyranoside), monostarch phosphate, distarch phosphate, acetylated starch, starch acetate esterified with acetic anhydride, starch acetate esterified with vinyl acetate, acetylated distarch adipate, acetylated distarch glycerol, starch sodium octenyl succinate, and combinations thereof.

Useful starches are commercially available under a variety of trade designations including, e.g., under the ETHYLEX and PEARL series of trade designations from Primary Products Ingredients Americas LLC (Schaumburg, Illinois) including ETHYLEX 2015 hydroxyethyl dent corn starch and PEARL dent unmodified corn starch, under the SOLFAREX series of trade designations from Coöperatie Koninklijke Avebe U.A. (Veendam, Netherlands) including SOLFAREX A55 corn starch, and SOLVICOL GP45 Plus potato starch from Coöperatie Koninklijke Avebe U.A. (Veendam, Netherlands).

The aqueous vinyl ester polymer emulsion preferably includes from 0% by weight to no greater than 50% by weight, at least 10% by weight, at least 20% by weight, from 20% by weight to 79% by weight, from 10% by weight to 40% by weight, from 10% by weight to 39% by weight, or even from 25% by weight to 35% by weight starch, based on dry weight.

### Dextrin

Useful dextrins include white potato dextrin, gold potato dextrin, corn dextrin, tapioca dextrin, and combinations thereof. The dextrin preferably has a cold water solubility of at least 10%, at least 50%, at least 70%, at least 80%, or even at least 85%, as reported by the manufacturer.

Useful dextrins are commercially available under a variety of trade designations including, e.g., under the STADEX and AVEDEX series of trade designations from Tate & Lyle (Decatur, Illinois) including STADEX 15 partly hydrolyzed starch dextrin having a cold water solubility of from 13% to 23%, STADEX 201 partly hydrolyzed starch dextrin having a cold water solubility of from 98% to 100%, STADEX 235 having a cold water solubility of from 95% to 100%, and AVEDEX 37LAC19 having a cold water solubility of from 99.5% to 100%, the cold water solubility values are as reported by the manufacturer.

The aqueous vinyl ester polymer emulsion preferably includes from 0% by weight to no greater than 50% by weight, at least 10% by weight, at least 20% by weight, from 20% by weight to 79% by weight, from 10% by weight to 40% by weight, from 10% by weight to 39% by weight, or even from 10% by weight to 25% by weight dextrin, based on dry weight.

### Optional Additives

The aqueous vinyl ester polymer emulsion optionally is formulated with other components including, e.g., plasticizers (e.g., glycols or polyethylene glycols), organic solvents (e.g., glycol ethers, alkanols (e.g., methanol, ethanol, and isopropanol), and combinations thereof), surfactants, chain transfer agents, rheology modifiers, crosslinkers, biocides, defoaming agents, fillers, pH modifiers (e.g., neutralizers), UV absorbers, pigments, colorants, antioxidants, other polymer emulsions, and combinations thereof.

Suitable plasticizers include, e.g., K-FLEX 850s plasticizer from Lanxess Deutschland GmbH (Germany), BENZOFLEX 50 plasticizer from Eastman Chemical Company (Kingsport, Tennessee), triacetin and combinations thereof.

Suitable surfactants include, e.g., nonionic, anionic, cationic and amphoteric surfactants.

Suitable chain transfer agents include organic compounds that include sulfur in bonded form (e.g., compounds having a thiol or sulfide group such as alkyl mercaptans, thiocarboxylic acids, thiocarboxylic esters, mercaptoalkanols, mercaptoalkyltrialkoxysilanes, thioglycols, dialkyl sulfides, diaryl sulfides, dialkyl disulfides and thiourea). Examples are tert-butyl mercaptan, tert-dodecyl mercaptan, thioglycolic acid ethylhexyl ester, mercaptoethanol, mercaptopropyltrimethoxysilane, thiodiglycol, ethylthioethanol, di-n-butyl sulfide, di-n-octyl sulfide, diphenyl sulfide, diisopropyl disulfide, 1,3-mercaptopropanol, 3-mercaptopropane-1,2-diol, 1,4-mercaptobutanol, thioglycolic acid, 3-mercaptopropionic acid, mercaptosuccinic acid, thioacetic acid, and thiourea. Particularly useful chain transfer agents include, e.g., tert-dodecyl mercaptan, n-dodecyl mercaptan, (2-ethylhexyl)thioglycolate, and combinations thereof.

Suitable fillers include, e.g., organic materials (e.g., carbon fibers) and inorganic particulate materials (e.g., calcium carbonates, silicates, inorganic fiber materials (e.g., glass fibers), and combinations thereof), mixtures of organic and inorganic fillers, (e.g., mixtures of glass fibers and carbon fibers and mixtures of carbon fibers and inorganic fillers). The emulsion optionally includes from 1% by weight to 5% by weight filler based on dry weight.

Suitable neutralizers include, e.g., inorganic bases, organic bases, and combinations thereof. Useful inorganic bases include, e.g., alkali metal hydroxides (e.g., lithium, sodium, potassium, magnesium, and ammonium hydroxides), alkali metal carbonates, alkali metal hydrogen carbonates and alkali metal salts of inorganic acids (e.g., sodium borate (borax), sodium phosphate, sodium pyrophosphate, and combinations thereof), and combinations thereof. Useful organic bases include, e.g., triethanolamine (TEA), diisopropanolamine, triisopropanolamine, aminomethyl propanol (2-amino-2-methyl-1-propanol), dodecylamine, cocamine, oleamine, morpholine, triamylamine, triethylamine, tetrakis(hydroxypropyl)ethylenediamine, L-arginine, methyl glucamine, isopropylamine, aminomethyl propanol, tromethamine (2-amino 2-hydroxymethyl-1,3-propanediol), and PEG-cocamine, and combinations thereof. Other alkaline materials can be used alone or in combination with the above-mentioned inorganic and organic bases.

Suitable UV absorbers include, e.g., benzotriazole derivatives, dimeric benzotriazole derivatives, halogenated benzotriazoles, benzophenone derivatives, triazine derivatives, dimeric triazine derivatives, diaryl cyanoacrylates, and combinations thereof.

Useful rheology modifiers include, e.g., water-soluble cellulose derivatives (e.g., cellulose ethers, hydroxyethyl cellulose, and combinations thereof), polyacrylic acid-based rheology modifiers, polyurethane-based rheology modifiers, xanthan gums, and combinations thereof.

The aqueous vinyl ester polymer emulsion optionally includes other polymer emulsions including, e.g., polymer emulsions commercially available under the PACE and ELVACE series of trade designations from H.B. Fuller Company (Vadnais Heights, Minnesota) including PACE 382 and 383 polyvinyl alcohol stabilized polyvinyl acetate homopolymer emulsions and ELVACE 734, 735, and 736 polyvinyl alcohol stabilized vinyl acetate/ethylene copolymer emulsions.

### Polymerization Process

The aqueous vinyl ester polymer emulsion can be prepared using any suitable emulsion polymerization process with or without pressurization. The emulsion polymerization is carried out in a suitable polymerization vessel and in the presence of an aqueous system that includes the vinyl ester monomer, the protective colloid, a free radical initiator, and any optional components. The aqueous reaction mixture can be maintained at a desired pH using a suitable buffering agent at a pH from 4.0 to 5.0, at temperatures ranging from 50° C. to 90° C., and at an appropriate pressure.

Any suitable sequence of combining the components used in the polymerization process can be used including, e.g., forming the protective colloid followed by the addition of monomer (i.e., vinyl ester) and optional comonomers, optionally with agitation (e.g., mixing). Additional aqueous medium, catalyst(s), vinyl ester monomer, and optional comonomers can be added to the polymerization vessel continuously, incrementally in stages, as single charges, and in multiple charges, while maintained under appropriate pressure.

The free radical initiator can initiate the emulsion polymerization processes and catalyze the reaction as the polymerization process proceeds. Suitable classes of free radical initiators include oxidizing agents, examples of which include peroxides, hydroperoxides, peroxodisulfates, percarbonates, peroxo esters, hydrogen peroxide, azo compounds, dibenzoyl peroxide, dicyclohexyl peroxodicarbonate, dibenzoyl peroxodicarbonate, succinic acid peroxide, lauryl peroxide, dilauroyl peroxide (DLP), methyl ethyl ketone peroxide, di-tert-butyl peroxide (DTBP), acetylacetone peroxide, tert-butyl hydroperoxide (TBHP), di-tert-amyl peroxide (DTAP), tert-amyl hydroperoxide (TARP), tert-butyl peroxide, cumene hydroperoxide, tert-butyl perneodecanoate, t-butyl pivalate, tert-amyl perpivalate, tert-butyl perpivalate, tert-butyl perneohexanoate, tert-butyl per-2-ethylhexanoate, benzoyl peroxide, tert-butyl perbenzoate, peroxodisulfates of lithium, sodium, potassium and ammonium, azodiisobutyronitrile, 2,2′-azobis(2-amidinopropane) dihydrochloride, 2-(carbamoylazo) isobutyronitrile, 4,4-azobis(4-cyanovaleric acid), and combinations thereof. Residual amounts of the oxidizing agents and their breakdown products after reaction can be present in the vinyl ester polymer emulsion.

The free radical initiator optionally is part of an initiator system that includes the oxidizing agent and a reducing agent. Preferably the initiator system is a water-soluble initiator system. Useful oxidizing agents are discussed above. Useful reducing agents include, e.g., salts of ascorbic acid and isoascorbic acid, sodium formaldehyde sulfoxylate, ferrous salts, sodium dithionite, sodium bisulfate, alkali metal salts of sulfurous acid (e.g., sodium sulfite and sodium hydrogen sulfite), disodium 2-hydroxy-2-sulfinatoacete, ascorbic acid, isoascorbic acid, sodium metabisulfite, alkali metal salts of disulfurous acid (e.g., sodium disulfite), bisulfite addition compounds with aliphatic aldehydes and ketones (e.g., acetone bisulfite), hydroxymethanesulfinic acid and its salts (e.g., sodium hydroxymethanesulfinate), and combinations thereof. Useful salts of ascorbic acid and isoascorbic acid include, e.g., lithium ascorbate, sodium ascorbate, potassium ascorbate, calcium ascorbate, magnesium ascorbate, ammonium ascorbate, alkylammonium ascorbates, lithium isoascorbate, sodium isoascorbate, potassium isoascorbate, calcium isoascorbate, magnesium isoascorbate, ammonium isoascorbate, alkylammonium isoascorbates, and combinations thereof. Reducing agents and their breakdown products after reaction might be present in the emulsion.

The initiator system optionally includes a transition metal catalyst, suitable examples of which include, e.g., salts of iron, cobalt, nickel, copper, vanadium, manganese, silver, gold, and combinations thereof. Examples of useful catalysts include iron (II) sulfate, cobalt (II) chloride, nickel (II) sulfate, copper (1) chloride, and combinations thereof.

The initiator system preferably is utilized in the polymerization process in an amount of from 0.1% by weight to 10% by weight, from 0.15% by weight to 5% by weight, or even from 0.2% by weight to 4% by weight, based on the weight of the monomers to be polymerized in the reaction step.

The amount of initiator preferably is from 0.05% by weight to 5.0% by weight, or even from 0.05% by weight to 1.0% by weight, based on dry weight.

During polymerization, the monomers (e.g., vinyl ester and optional comonomer(s)) can be wholly or partly neutralized with bases including, e.g., before the polymerization, during the polymerization, and combinations thereof. Useful bases include, e.g., alkali metal and alkaline earth metal compounds (e.g., sodium hydroxide, potassium hydroxide, calcium hydroxide, magnesium oxide, sodium carbonate, sodium bicarbonate, and combinations thereof); ammonia; primary, secondary and tertiary amines, such as ethylamine, propylamine, monoisopropylamine, monobutylamine, hexylamine, ethanolamine, dimethylamine, diethylamine, di-n-propylamine, tributylamine, triethanolamine, dimethoxyethylamine, 2-ethoxyethylamine, 3-cthoxypropylamine, dimethylethanolamine, diisopropanolamine, morpholine, ethylenediamine, 2-diethylamino-ethylamine, 2,3-diaminopropane, 1,2-propylenediamine, dimethylaminopropylamine, neopentanediamine, hexamethylenediamine, 4,9-dioxadodecane-1,12-diamine, polyethylene-imine, polyvinylamine, and combinations thereof; and combinations thereof.

One example of a useful process for preparing the emulsion polymer includes dry blending polyvinyl alcohol and starch, dextrin or a combination thereof, to form a first mixture, adding the first mixture, with mixing, to the water present in a reaction vessel, heating the resulting mixture to an elevated temperature (e.g., from 85° C. to 90° C.) that is sufficiently high to dissolve the solids (i.e., solubilize the solid components), and holding the mixture at the elevated temperature for a sufficient period of time to allow all of the solids to dissolve and form the protective colloid. The temperature of the mixture is then lowered before starting the polymerization reaction. The vinyl ester monomer is then added to the reaction vessel followed by addition of the initiator (e.g., the oxidizing agent of a redox initiator system) to start the polymerization reaction in the presence of the protective colloid. The mixture can be homogenized using agitation (e.g., mixing) and additional initiator/catalyst can be added throughout the polymerization process as needed. The reaction temperature is maintained by adding or removing energy to the system to control the reaction rate. Alternatively, the rate at which the monomer, catalyst, or both are fed into the reaction vessel can be used to control the reaction rate. Once the reactive components have been added to the vessel, the batch is treated with additional catalyst to allow any remaining monomer to react and to complete the reaction. The resulting emulsion polymer is then cooled to room temperature, filtered, and transferred to storage.

The polymerization time depends on the temperature and the desired properties of the final product. Useful reaction times range from 1.5 hours to 10 hours at temperatures of from 50° C. to 100° C., more preferably from 60° C. to 90° C.

Another useful emulsion polymerization process includes sequentially adding the polyvinyl alcohol, and starch, dextrin, or a combination thereof, to a reaction vessel with water, increasing the temperature of the reaction vessel to dissolve all of the solids and form the protective colloid, cooling the reaction vessel, adding monomers (e.g., vinyl ester monomer and optional comonomer(s)) and catalyst and allowing the polymerization reaction to proceed in the presence of the protective colloid under the appropriate temperature and pressure conditions to form the emulsion polymer.

### Use

The aqueous vinyl ester polymer emulsion can be formulated such that the aqueous vinyl ester polymer emulsion, without additional components, is suitable for use as a variety of compositions including, e.g., adhesive compositions, binders, coatings, and combinations thereof. Alternatively, the aqueous vinyl ester polymer emulsion can be formulated with additional components to form a variety of compositions including, e.g., adhesive compositions, binders, paints, coatings, and combinations thereof. Adhesive compositions preferably include from 5% by weight to 100% by weight, from 20% by weight to 90% by weight, or even from 30% by weight to 80% by weight of the aqueous vinyl ester polymer emulsion based on the total weight of the adhesive composition.

Optional additional components useful for formulating compositions such as adhesive compositions, binders, paints, and coatings include, e.g., plasticizers, viscosity and rheology modifiers, tackifiers, fillers, humectants, surfactants, dispersants, organic solvents (e.g., glycol ethers, alcohols (e.g., methanol, ethanol, and isopropanol), and combinations thereof), coalescents, anti-foam agents, coupling agents, antistatic agents, biocides, pigments, dyes, other polymer emulsions (e.g., those other polymer emulsions set forth above and incorporated herein), and combinations thereof.

Classes of plasticizers suitable for formulating adhesive compositions, binders, paints, and coatings include, e.g., benzoates, dibenzoates, phthalates, phosphates, bio-based plasticizers (e.g., castor oil and citrates), triglycerides, and combinations thereof. Useful commercially available plasticizers suitable for formulating adhesive compositions, binders, paints, and coatings include the plasticizers set forth above with respect to the vinyl ester polymer emulsion, which are incorporated herein. Adhesive compositions preferably include from 0% by weight to 30% by weight, from 1% by weight to 30% by weight, or even from 1% by weight to 20% by weight plasticizer, based on the total weight of the adhesive compositions.

Classes of humectants suitable for formulating adhesive compositions, binders, paints, and coatings include, e.g., ureas, glycols, glycerol, sugar alcohols, magnesium chloride, polyvinyl alcohol, and combinations thereof. Adhesive compositions preferably include from 0% by weight to 20% by weight, from 1% by weight to 20% by weight, or even from 1% by weight to 15% by weight humectant, based on the total weight of the adhesive composition.

Useful classes of rheology modifiers for formulating adhesive compositions, binders, paints, and coatings include, e.g., thickeners, polyurethane dispersions, carboxymethyl cellulose, carboxyethyl cellulose, carboxypropyl cellulose, xanthan gum, polyacrylates, and combinations thereof. Adhesive compositions preferably include from 0% by weight to 5% by weight, or even from 0.05% by weight to 5% by weight rheology modifiers, based on the total weight of the adhesive composition.

Useful classes of fillers suitable for formulating adhesive compositions, binders, paints, and coatings include, e.g., clays, kaolin, gypsum, talc, calcium carbonate, magnesium carbonate, silicon dioxide, aluminum oxide, sodium oxide, potassium oxide, calcium oxide, iron oxide, magnesium oxide, titanium dioxide, sodium silicate, potassium silicate, calcium silicate, feldspar, and combinations thereof. Adhesive compositions optionally include from 0% by weight to 30% by weight, from 1% by weight to 30% by weight, or even from 1% by weight to 25% by weight filler based on the total weight of the adhesive composition.

Suitable surfactants include, e.g., nonionic, anionic, cationic and amphoteric surfactants. The adhesive compositions, binders, paints, and coatings optionally include from 0% by weight to 2% by weight, from 0.1% by weight to 1% by weight, or even from 0.1% by weight to 2% by weight surfactant, based on the total weight of the composition.

Suitable dispersants include, e.g., nonionic, anionic, cationic and amphoteric dispersants. The adhesive compositions, binders, paints, and coatings optionally include from 0% by weight to 2% by weight, from 0.1% by weight to 1% by weight, or even from 0.1% by weight to 2% by weight dispersant, based on the total weight of adhesive composition.

Useful binder compositions include the aqueous vinyl ester polymer emulsion (e.g., from 10% by weight to 100% by weight, from 10% by weight to 35% by weight, or even from 15% by weight to 30% by weight aqueous vinyl ester polymer emulsion), organic solvent (e.g., methanol) (e.g., from 0% by weight to 30% by weight, from 10% by weight to 30% weight, or even from 15% by weight to 30% by weight organic solvent), coupling agent (e.g., from 0% by weight to 1% by weight, or even from 0.1% by weight to 1% by weight coupling agent), antistatic agent (e.g., from 0% by weight to 0.5% by weight, or even from 0.1% by weight to 0.5% by weight antistatic agent), and optionally surfactant, dispersant, defoaming agents, and combinations thereof in the amounts set forth in the above paragraphs (the percent by weight values being based on the total weight of the binder composition). One example of a useful commercially available coupling agent is SILQUEST A187 epoxy functional silane from Momentive Performance Materials Inc., Niskayuna, New York. Useful commercially available antistatic agents include, e.g., HOSTASTAT HS 1 FF alkane sulfonate from Clariant International Ltd. (Muttenz, Switzerland) and LAROSTAT 264A quaternary ammonium cationic antistatic agent from BASF (Florham Park, New Jersey).

One example of a useful paint is a wash away paint (e.g., removable road paint) that includes the aqueous vinyl ester polymer emulsion and pigment, dye or a combination thereof.

One example of a useful coating composition includes the aqueous vinyl ester polymer emulsion (from 10% by weight to 100% by weight, or even from 10% by weight to 80% by weight aqueous vinyl ester polymer emulsion), and optionally a coalescent, e.g., (e.g., glycol ethers, alcohols (e.g., methanol, ethanol, and isopropanol), and combinations thereof) (e.g., from 0% by weight to 20% by weight, or even from 1% by weight to 10% weight coalescent) (the percent by weight values being based on the total weight of the coating composition).

The aqueous vinyl ester polymer emulsion and compositions that include the aqueous vinyl ester polymer emulsion can be applied continuously or discontinuously (e.g., a continuous or discontinuous coating) using a variety of application techniques including, e.g., extrusion, spraying, soaking, immersing, impregnating, saturating, coating, e.g., roll coating, curtain coating, brush coating, beater deposition, and combinations thereof.

The aqueous vinyl ester polymer emulsion and compositions that include the aqueous vinyl ester polymer emulsion can be applied to or incorporated in a variety of substrates including, e.g., modified substrates (e.g., treated substrates, coated substrates, and combinations thereof including e.g., surface modified substrates, water resistant substrates, and clay coated substrates), unmodified substrates (e.g., untreated substrates and uncoated substrates), cellulose-based substrates (e.g., paper, bleached paper, cartons, fiberboards, and wood), sheets, lofty fibrous products, filaments, strands, ropes, rolls, batts, woven and nonwoven webs, films, fibers (e.g., natural fibers (e.g., wood pulp, jute, cotton, silk, wool, and combinations thereof), synthetic polymer fibers (e.g., polyester, polyolefin (e.g., polypropylene, polyethylene, and copolymers of polyolefins and polyesters), rayon, polyamide, polyacrylamide, polyurethane, polyacrylonitrile, polyvinyl acetate and polyvinyl chloride fibers, and combinations thereof including copolymers thereof, bicomponent fibers (e.g., sheath core fibers), glass fibers, and combinations thereof), fiberglass, laminates, and combinations thereof.

Useful woven and nonwoven webs include, e.g., glass fibers (e.g., fiberglass), natural fibers (e.g., wood pulp, jute, cotton, silk, wool, and combinations thereof), synthetic polymer fibers (e.g., polyester, polyolefin (e.g., polypropylene, polyethylene, and copolymers of polyolefins and polyesters), rayon, polyamide, polyacrylamide, polyurethane, polyacrylonitrile, polyvinyl acetate and polyvinyl chloride fibers, and combinations thereof including copolymers thereof, bicomponent (e.g., sheath core) fibers, and combinations thereof), and combinations thereof.

Useful films include polymer films, e.g., polyester (e.g., biaxially oriented polyester film), polyolefin (e.g., polypropylene, polyethylene, and copolymers of polyolefins and polyesters), metallized films (e.g., mPET and aluminum), rayon, polyamide, polyacrylamide, polyurethane, polyacrylonitrile, polyvinyl acetate and polyvinyl chloride fibers, and combinations thereof.

Adhesive compositions that include the aqueous vinyl ester polymer emulsion are useful for bonding a variety of substrates including, e.g., paper to paper, paper to paperboard, film to paper, paper to foil, paper to metallized polyester film (MET film), film to film, film to foil, film to MET film, woven webs to paper, film, woven webs and nonwoven webs, nonwoven webs to paper, film and nonwoven webs, fibers to fibers, and combinations thereof. Adhesive compositions that include the aqueous vinyl ester polymer emulsion are also useful for bonding packaging articles and various substrates used in packaging articles including, e.g., paper, corrugated paper-type packaging materials, paper bags, cardboard boxes, compostable containers, film to metal foil packaging articles (e.g., chip bags and candy bar wrappers), paper to film to metal foil packaging articles (e.g., juice containers), and combinations thereof.

In one useful application, the aqueous vinyl ester polymer emulsion formulated as a wash away paint (e.g., removable road paint) is suitable for a variety of uses including, e.g., temporarily marking surfaces (e.g., construction materials, road ways, and sidewalks), and subsequently washing away the marking. The aqueous vinyl ester polymer emulsion formulated as a wash away paint is also suitable for a variety of other applications including, e.g., other construction applications, Department of Defense and military applications, arts and crafts uses, and temporary signage, and on a variety of surfaces including, e.g., textiles, apparel, and combinations thereof.

In another useful application, the aqueous vinyl ester polymer emulsion is applied as a temporary protective coating on articles, e.g., solar panels. The temporary protective coating can subsequently be washed away (e.g., with rain) after a period of time (e.g., when solar panels are installed in a permanent location).

The aqueous vinyl ester polymer emulsion also can be used in articles for which properties such as, e.g., repulpability, compostability, recyclability, and combinations thereof are desired.

The invention will now be described by way of the following examples. All parts, ratios, percents and amounts stated in the Examples are based on dry weight unless otherwise specified.

### EXAMPLES

### Test Procedures

Test procedures used in the examples include the following. All ratios and percentages are by dry weight unless otherwise indicated. The procedures are conducted at room temperature (i.e., an ambient temperature of from about 20° C. to about 25° C.) unless otherwise specified.

### Viscosity Test Method

Viscosity is determined using a Brookfield viscometer model RVT at 20 rotations per minute and a number 5 spindle. The sample composition is maintained at 25° C. and the measurement is taken within 1 hour of making the composition unless otherwise specified.

The results are reported in centipoise (cP) and as the Initial Viscosity.

### Change in Viscosity Test Method

The change in viscosity is determined by storing the sample to be tested in a sealed container at 50° C. for 14 days and then testing the sample according to the Viscosity Test Method at 25° C. The results are reported in centipoise (cP) as the Stored Viscosity. The change in viscosity is calculated by subtracting the Initial Viscosity from the Stored Viscosity and the result is reported in cP.

### Microbial Resistance Test Method

Microbial resistance is determined by using a BUG CHECK BF test kit targeting bacterial and fungal growth from Avalon International Corporation (Northfield, Illinois) or an equivalent test kit. A sample is prepared and then incubated for seven days at 37° C., according to the instructions in the test kit. Daily visual observations of growth are made and recorded. If no microbial growth is seen at seven days, the sample is recorded as being microbial resistant. If microbial growth is seen on or before seven days, the sample is recorded as not microbial resistant.

### Redispersibility Test Method

A room temperature aliquot of the sample to be tested is drawn down on an 8 inch (in)×10 in×0.25 in (20 cm×25 cm×0.64 cm) glass plate using a Number 30 wire wound rod and allowed to dry at room temperature. A single drop of water is applied to the dried sample using an eye dropper and a timer is simultaneously started. The action of the water on the dried sample is observed with the naked eye and the amount of time that elapses before the dried sample dissolves is recorded. The dried sample is determined to have dissolved when it exhibits a milk-like appearance, breaks apart, and releases from the glass plate. The test is repeated three times for each sample to be tested and the average time to dissolve of the three samples is recorded in minutes. If the sample is dissolved at one minute, it is deemed to be redispersible. If the sample has not dissolved at one minute, it is determined to be not redispersible.

### Film Forming Test Method

An aliquot of a uniform aqueous polymer emulsion is drawn down on an 8 in×10 in×0.25 in (20 cm×25 cm×0.64 cm) glass plate using a 10 mil (0.025 cm) applicator to form a 10 mil (0.025 cm) film on the glass plate. The film is allowed to dry. The film is then observed with the naked eye to determine if it has coalesced. If the sample film has coalesced and does not flake, crack or exhibit a chalky appearance, the sample is determined to be film forming.

### Minimum Film Forming Temperature (MFFT) Test Method

The minimum film forming temperature (MFFT) is determined according to ASTM D2354-10el entitled, “Standard Test Method for Minimum Film Formation Temperature (MFFT) of Emulsion Vehicles,” and reported in degrees Celsius (° C.).

### Particle Size Determination Test Method

The number average mean particle size and the volume average mean particle size are determined using a Beckman Coulter LS 13 320 Particle Size Analyzer and the polyvinyl acetate model supplied by the manufacturer. A 30 milliliter (mL) plastic cup is filled with reverse osmosis water. A plastic transfer pipette is used to transfer a small drop of sample to the cup by submerging the pipette tip in the water and then squeezing and releasing the bulb, which causes the sample to be mixed in the water to form the diluted sample.

From 5 mL to 7 mL of water is removed from the sample loading port. A few drops of the diluted sample are added to the sample loading port using a plastic pipette. Any remaining sample is then returned to the diluted sample cup and the pipette is reinserted into the sample port and submerged just below the surface. The bulb of the pipette is squeezed and then released to facilitate mixing and establish a uniform dilution. Once the polarization intensity differential scattering (PIDS) obscuration level is from 40% to 60%, the analysis is started. The number average mean particle size and the volume average mean particle size are determined and reported in microns (μm).

### Open Time Test Method

The open time of a sample composition is determined by first securing a sheet of copy paper (8.5 in by 11 in) (22 cm×28 cm) to a flat, smooth surface with tape. Placing a sheet of Mylar (4 in by 2 in) (10 cm×5 cm) on top of the paper sheet such that it overlaps by from about 2 mm to 3 mm. A 3 mil size drawn down die is placed on the Mylar and the pocket of the die is filled with the sample composition. The drawn down die is then pulled along the length of the paper with a quick and steady motion. A stopwatch is started immediately after the adhesive has been applied. At 10 seconds, a 4 in by 0.6 in (10 cm×1.5 cm) strip of copy paper is placed over the adhesive sample and pressed against the adhesive with finger pressure. This process is repeated in 10 second intervals until a strip of the paper no longer bonds to the adhesive. The test samples are then allowed to dry overnight under ambient conditions. The entire process is repeated two more times.

After the test samples have dried, the strips of paper are slowly peeled from the adhesive. The time corresponding to the first strip that exhibits 0% fiber tear is reported as the open time for the sample. The average open time for all three samples is calculated and reported as the open time in seconds.

### Examples 1-5

The polyvinyl acetate emulsions of Examples 1 and 2 were prepared by first adding 315 mL water to a clean vessel and turning on mixing. The mixing was continued throughout the process. Sodium bicarbonate was slowly added to the water and mixed for a period of five minutes. Then dry polyvinyl alcohol was added to the cook tank with continued mixing. After the polyvinyl alcohol was evenly dispersed throughout the water, the mixture was heated to from 85° C. to 90° C. and held at the elevated temperature with mixing for at least 30 minutes. The mixture was then cooled to from 50° C. to 55° C. Starch and dextrin in the amounts set forth in Table 1 (based on dry weight) were then added to the reaction vessel. The mixture was then heated to from 78° C. to 82° C. and maintained at the elevated temperature, with mixing, until all of the solids had dissolved (a minimum period of 60 minutes) to form a protective colloid. The temperature of the cook tank was then decreased to from 62° C. to 65° C., and the mixture was then transferred to a reactor and mixing was started and continued throughout the process.

An initial charge of vinyl acetate monomer was then fed into the reaction vessel. After 15 minutes and after the temperature of the reaction vessel returned to 62° C., an initial amount of reducing agent was added to the mixture. After five minutes the delayed oxidizing agent feed was uniformly fed into the reactor over a period of four hours. During the reaction, the reaction temperature slowly rose. When the mixture reached a temperature of from 67° C. to 69° C., the vinyl acetate monomer feed was started and uniformly fed to the reactor over a period of three hours. One hour after the delayed oxidizing agent feed was started, the delayed reducing agent feed was started uniformly fed into the reactor over a period of three hours. The reaction temperature rose and was maintained at from 87° C. to 89° C. throughout the remainder of the reaction. When the reaction was complete, the temperature was reduced to from 60° C. to 65° C. and treated with redox reagents. Once the treatments of redox reagents were complete, the reactor was cooled to below 40° C., and the pH was adjusted to from 4.0 to 4.5. The resulting product was filtered and transferred to storage. The resulting polymer emulsion had the solids content, based on dry weight, and pH set forth in Table 1.

The resulting polyvinyl acetate emulsions were tested for pH at 25° C. and according to the Viscosity, Particle Size Distribution, Film Forming, and MFFT Test Methods (with the exception that as to the Viscosity test method, the temperature and rotations per minute were as set forth in Table 1 below), and the results are set forth below in Table 1.

TABLE 1

| | Example 1 | Example 2 | Example 3 | Example 4 | Example 5 |
|---|---|---|---|---|---|
| % Starch¹, dry | 30.63 | 30.63 | 10.83 | 16.48 | 0.00 |
| weight basis* | | | | | |
| % Dextrin², dry | 10.83 | 9.69 | 30.63 | 0.00 | 54.14 |
| weight basis | | | | | |
| % PVOH³, dry | 2.25 | 3.39 | 2.25 | 2.25 | 2.25 |
| weight basis | | | | | |
| % VAM⁴ dry | 56.29 | 56.29 | 56.29 | 81.27 | 43.61 |
| weight basis | | | | | |
| % Protective | 44:56 | 44:56 | 44:56 | 44:56 | 56:44 |
| Colloid to VAM | | | | | |
| ratio | | | | | |
| % solids | 54.1 | 55.3 | 55.2 | 56.31 | 56.95 |
| pH at 25° C. | 4.5 | 4.5 | 4.5 | 4.5 | 4.2 |
| Viscosity (cP) | | | | | |
| 20 rpm @ 21° C. | 54.1 | 55.3 | 55.2 | 3240 | 360 |
| 100 rpm @ 21° C. | 1500 | 2255 | 646 | 1852 | 362 |
| Particle Size | | | | | |
| (μm) | | | | | |
| Volume Average | 32.88 | 58.74 | 115.4 | 26.63 | 10.17 |
| Mean | | | | | |
| Number Average | 0.282 | 0.154 | 0.286 | 0.276 | 0.286 |
| Mean | | | | | |
| Dry Film | Opaque, | Opaque, | Opaque, | Opaque, | Opaque, |
| appearance | coalesced | coalesced | coalesced | coalesced | coalesced |
| MFFT, ° C. | 1.5 | 2.0 | 5.0 | 1.5 | 1.8 |
| Redispersible | Yes | Yes | Yes | Yes | Yes |
| Open Time | 70 | 70 | 70 | 40 | 100 |
| (seconds) | | | | | |
| Observations | Free of | Free of | Free of | Free of | Free of |
| After Storage at | gelling and | gelling and | gelling and | gelling and | gelling and |
| room temperature | phase | phase | phase | phase | phase |
| at 180 days | separation | separation | separation | separation | separation |

*The dry weight bases values set forth in Table 1 are calculated based on the total dry weight of the ingredients of the protective colloid and the vinyl acetate monomer
¹= ETHYLEX 2015 hydroxyethylated dent corn starch (Primary Products Ingredients Americas LLC, Schaumburg, Illinois)
²= STADEX 201 canary dextrin from waxy corn starch having a cold water solubility of from 98-100 (Tate & Lyle, Decatur, Illinois)
³= SELVOL 540 polyvinyl alcohol having 88 mole % hydrolysis (Sekisui Specialty Chemicals America, LLC, Dallas, Texas)
⁴= vinyl acetate monomer

### Example 6

The adhesive composition of Example 6 was prepared by sequentially combining 360.83 grams (g) of the aqueous vinyl acetate polymer emulsion of Example 4, 42.0 g K-FLEX 850S plasticizer (Emerald Kalma Chemical LLC, Vancouver, Washington), 21.25 g KAOPRIME 22P kaolin clay (Thiele Kaolin Company, Sandersville, Georgia), and 0.43 g FOAMASTER MO2172 defoamer (BASF Corporation, Florham, New Jersey) with mixing for a period of 30 minutes.

### Example 7

The adhesive composition of Example 7 was prepared by sequentially combining 415.23 g of the aqueous vinyl acetate polymer emulsion of Example 4, 8.5 g diethylene glycol monobutyl ether, 0.85 g ALCOGUN 296W anionic, aqueous solution of sodium polyacrylate (Nouryn Specialty Chemicals B.V., Amsterdam, Netherlands), and 0.43 g F&DC Blue #1 dye with mixing for a period of 30 minutes.

### Example 8

The adhesive composition of Example 8 was prepared by combining 231.63 g of the aqueous vinyl acetate polymer emulsion of Example 4 with 2.13 g PLURONIC L62 nonionic surfactant (BASF Corporation, Florham Park, New Jersey), 170 g PACE 383 polyvinyl alcohol stabilized polyvinyl acetate homopolymer emulsion (H.B. Fuller Company, Vadnais Heights, Minnesota), and 21.25 g of a 70% sorbitol in water solution with mixing for a period of 30 minutes.

Other embodiments are within the claims.

What is claimed is:

1. An aqueous vinyl ester polymer emulsion comprising:
a protective colloid comprising polyvinyl alcohol and a component selected from the group consisting of starch, dextrin, and combinations thereof;
polyvinyl ester; and
water,
the polyvinyl ester being stabilized in the emulsion by the protective colloid.

2. The aqueous vinyl ester polymer emulsion of claim 1, comprising
from 20% by weight to 60% by weight of the polyvinyl ester, based on dry weight,
wherein the protective colloid comprises
from 1% by weight to 5% by weight polyvinyl alcohol, based on dry weight, and
from 20% by weight to 79% by weight of the component selected from the group consisting of starch, dextrin, and combinations thereof, based on dry weight.

3. The aqueous vinyl ester polymer emulsion of claim 1, wherein the protective colloid comprises starch and dextrin.

4. The aqueous vinyl ester polymer emulsion of claim 1, wherein the protective colloid comprises
from 10% by weight to 40% by weight starch, based on dry weight, and
from 10% by weight to 40% by weight dextrin, based on dry weight.

5. The aqueous vinyl ester polymer emulsion of claim 1, wherein the ratio of starch to dextrin is from 90:10 to 10:90.

6. The aqueous vinyl ester polymer emulsion of claim 1, wherein the protective colloid comprises from 1% by weight to 5% by weight polyvinyl alcohol, based on dry weight.

7. The aqueous vinyl ester polymer emulsion of claim 1, wherein the protective colloid comprises
from 1% by weight to 5% by weight polyvinyl alcohol, based on dry weight, and
from 20% by weight to 79% by weight of the component selected from the group consisting of starch, dextrin, and combinations thereof, based on dry weight.

8. The aqueous vinyl ester polymer emulsion of claim 1, comprising
from 20% by weight to 60% by weight polyvinyl ester, based on dry weight, and
from 40% by weight to 80% by weight protective colloid, based on dry weight.

9. The aqueous vinyl ester polymer emulsion of claim 1, wherein
the polyvinyl ester comprises polyvinyl acetate,
the aqueous vinyl ester polymer emulsion comprises
from 20% by weight to 60% by weight polyvinyl acetate, based on dry weight, and
from 40% by weight to 80% by weight protective colloid, based on dry weight, and
the protective colloid comprises from 1% by weight to 5% by weight polyvinyl alcohol, based on dry weight.

10. The aqueous vinyl ester polymer emulsion of claim 1, comprising
from 20% by weight to 60% by weight polyvinyl ester, based on dry weight, the polyvinyl ester being selected from the group consisting of polyvinyl acetate, vinyl acetate/ethylene copolymers, and combinations thereof, and
from 40% by weight to 80% by weight protective colloid, based on dry weight, the protective colloid comprising
from 1% by weight to 5% by weight polyvinyl alcohol, based on dry weight, and
from 20% by weight to 79% by weight of the component selected from the group consisting of starch, dextrin, and combinations thereof, based on dry weight.

11. The aqueous vinyl ester polymer emulsion of claim 1, wherein the protective colloid comprises starch and the starch comprises hydroxyethyl starch, hydroxypropyl starch, or a combination thereof.

12. The aqueous vinyl ester polymer emulsion of claim 1, wherein the protective colloid comprises a bio-based content of at least 30% by weight, based on dry weight.

13. The aqueous vinyl ester polymer emulsion of claim 1, comprising from 20% by weight to 80% by weight polyvinyl ester, based on dry weight.

14. The aqueous vinyl ester polymer emulsion of claim 1, wherein the polyvinyl ester is selected from the group consisting of polyvinyl acetate, vinyl acetate/ethylene copolymers, and combinations thereof.

15. The aqueous vinyl ester polymer emulsion of claim 1, wherein the emulsion exhibits an open time of at least 45 seconds.

16. The aqueous vinyl ester polymer emulsion of claim 1, wherein the aqueous vinyl ester polymer emulsion exhibits a viscosity of no greater than 3000 centipoise when measured at 25° C. and a solids content of 56%.

17. The aqueous vinyl ester polymer emulsion of claim 1, wherein the dried vinyl ester polymer emulsion is redispersible in water.

18. An aqueous vinyl ester polymer emulsion prepared by a polymerization process, the polymerization process comprising:
polymerizing monomers in the presence of a protective colloid to produce the aqueous vinyl ester polymer emulsion,
the monomers comprising vinyl ester monomers, and
the protective colloid comprising polyvinyl alcohol and a component selected from the group consisting of starch, dextrin, and combinations thereof.

19. The aqueous vinyl ester polymer emulsion of claim 18, wherein the monomers further comprise at least one comonomer.

20. A composition comprising:
the aqueous vinyl ester polymer emulsion of claim 1,
the composition being selected from the group consisting of
an adhesive composition, the adhesive composition further comprising a component selected from the group consisting of plasticizer, humectant, surfactant, defoamer, filler, organic solvent, a second vinyl ester polymer emulsion, rheology modifier, and combinations thereof,
a binder composition, the binder composition further comprising organic solvent selected from the group consisting of methanol, ethanol, isopropanol, and combinations thereof,
a paint composition, the paint composition further comprising pigment, and
combinations thereof.

21. An adhesive composition comprising:
from 5% by weight to 99.95% by weight of the aqueous vinyl ester polymer emulsion of claim 1; and
a component selected from the group consisting of
from 1% by weight to 30% by weight plasticizer,
from 1% by weight to 20% by weight humectant,
from 0.05% by weight to 5% by weight rheology modifier,
from 0.1% by weight to 1% by weight surfactant,
from 0.1% by weight to 1% by weight dispersant; and
combinations thereof.

22. An article comprising:
a first fibrous sheet; and
the dried vinyl ester polymer emulsion of claim 1 disposed on the fibrous sheet.

23. A method of making an aqueous vinyl ester polymer emulsion, the method comprising:
combining polyvinyl alcohol, a component selected from the group consisting of starch, dextrin, and combinations thereof, and water to form a mixture;
heating the mixture to an elevated temperature to form a protective colloid;
adding monomers comprising vinyl ester monomers to the protective colloid; and
polymerizing the monomers to form an aqueous polyvinyl ester emulsion stabilized by the protective colloid.
